(19) United States
(12) Patent Application Publication
(10) Pub. No.: US 2005/0144970 A1
(43) Pub. Date: Jul. 7, 2005

(54) Refrigerator

(75) Inventors: Young-jin Cho, Kwangju (KR); Hyun-sang Yoo, Kwangju (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/879,536

(22) Filed: Jun. 30, 2004

(30) Foreign Application Priority Data
Jan. 7, 2004 (KR) 2004-972

(51) Int. Cl. G05D 23/32; A47B 96/04; F25D 11/02; F25D 25/00

(52) U.S. Cl. 62/441; 62/465; 312/405

(57) ABSTRACT

A refrigerator having: a main body with a freezing compartment and a refrigerating compartment, each having an opening; a freezing compartment door and a refrigerating compartment door provided on the main body, each to rotatably open and close the respective openings of the freezing and refrigerating compartments; an auxiliary freezing compartment, provided on the freezing compartment door to store food, and having an opening; and a freezing compartment home bar door to open and close the opening of the auxiliary freezing compartment. Thus, according to the present invention, the freezing compartment door has the auxiliary freezing compartment and the freezing compartment home bar door, which allows a user to store food without opening the freezing compartment door, and minimizes a leakage of cooling air from the freezing compartment.

### CROSS-REFERENCE TO RELATED APPLICATIONS

This application claims the benefit of Korean Patent Application No. 2004-972, filed Jan. 7, 2004 in the Korean Intellectual Property Office, the disclosure of which is incorporated herein by reference.

### BACKGROUND OF THE INVENTION

1. Field of the Invention

The present invention relates to a refrigerator, and more particularly, to a refrigerator that has an auxiliary freezing compartment having a front opening to store food in a freezing compartment door and a freezing compartment home bar door to open/close the front opening of the auxiliary freezing compartment.

2. Description of the Related Art

A conventional refrigerator has a freezing compartment and a refrigerating compartment divided in an up-and-down direction. Recently, a refrigerator having a freezing compartment and a refrigerating compartment divided in a right-and-left direction, a so-called side-by-side type refrigerator has been put on the market.

As is shown in FIGS. 1 and 2, and disclosed in U.S. Publication 2003/132690, a refrigerator comprises a main body 110 divided by a partition into a freezing compartment and a refrigerating compartment, each having a front opening. Additionally, a freezing compartment door 120 and a refrigerating compartment door 160 are provided to rotatably open the front openings of the freezing compartment and the refrigerating compartment, respectively.

The refrigerating compartment door 160 has an auxiliary refrigerating compartment 161 that allows a part of the refrigerating compartment in communication with the outside to accommodate food in the refrigerating compartment without opening the refrigerating compartment door 160. The auxiliary refrigerating compartment 161 has a front opening 125′. The front opening 125′ of the auxiliary refrigerating compartment 161 has a refrigerating compartment home bar door 162 that reciprocates between an opened position where the front opening 125′ is opened by rotating in an up-and-down direction, and a closed position where the front opening 125′ is closed.

The refrigerator requires a locking unit 123 so that the refrigerating compartment home bar door 162 can be locked to and released from the front door 125′. Thus, a lever unit 141 rotated on a hinge pin 141c is provided between the refrigerating compartment home bar door 162 and the auxiliary refrigerating compartment 161. The lever unit 141 has a hook 141b protruding from a side of a lever part 141a is provided. The hook 141b is locked to and released from a protrusion 154 protruding from an upper part of the auxiliary refrigerating compartment 161. If a user rotates the lever part 141a and detaches the hook 141b from the protrusion 154 when the hook 141b of the lever unit 141 is locked to the protrusion 154, the refrigerating compartment home bar door 162 rotates with respect to a rotation pin 124 provided at a lower part of the refrigerating compartment home bar door 162, and is opened. Thus, food may be stored and accessed in the auxiliary refrigerating compartment 161 without opening the refrigerating compartment door 160, thus reducing a leakage of cooling air.

But the freezing compartment doesn't have an auxiliary freezing compartment and a freezing compartment home bar door, which causes a lot of leakage of cooling air when the freezing compartment is opened/closed.

### SUMMARY OF THE INVENTION

Accordingly, it is an aspect of the present invention to provide a refrigerator comprising an auxiliary freezing compartment and a freezing compartment home bar door in a freezing compartment door, which allows a user to store food in the freezing compartment door without opening the freezing compartment door, and minimizes a leakage of cooling air of the freezing compartment.

The foregoing and/or other aspects of the present invention are achieved by providing a refrigerator comprising: a main body with a freezing compartment and a refrigerating compartment each compartment having a door opening; a freezing compartment door and a refrigerating compartment door provided on the main body to rotatably open and close the respective door openings; an auxiliary freezing compartment provided on the freezing compartment door to store food, and having an opening; and a freezing compartment home bar door to open and close the front door of the auxiliary freezing compartment.

According to an aspect of the invention, the refrigerating compartment door comprises an auxiliary refrigerating compartment to store food, having an opening and a refrigerating compartment home bar door to open and close the opening of the auxiliary refrigerating compartment.

According to an aspect of the invention, the refrigerator further comprises hook device comprising a hook provided at one of the auxiliary freezing compartment and the freezing compartment home bar door and a locker provided at the remaining one of the auxiliary freezing compartment and the freezing compartment home bar door, to be elastically locked with and released from the hook.

According to an aspect of the invention, the refrigerator further comprises a locker accommodating part provided at one of the auxiliary freezing compartment and the freezing compartment home bar door, the locker accommodating part is provided with an elastic member to press the locker and a stopper to prevent the locker from escaping the locker accommodating part.

According to an aspect of the invention, a hinge is provided at a lower part of the freezing compartment home bar door to allow the freezing compartment home bar door to rotate with respect to the auxiliary freezing compartment and the hook device being provided at an upper part of the freezing compartment home bar door.

According to an aspect of the invention, the refrigerator further comprises a magnetic connector comprising: a permanent magnet provided at an edge of one of the auxiliary freezing compartment and the freezing compartment home bar door; and a magnetic substance provided at the remaining one of the auxiliary freezing compartment and the freezing compartment home bar door to cooperate with the permanent magnet.

According to an aspect of the invention, a hinge is provided at a lower part of the freezing compartment home bar door to allow the freezing compartment home bar door to rotate with respect to the auxiliary freezing compartment and the hook device being provided at an upper part of the freezing compartment home bar door.

Additional and/or other aspects and advantages of the invention will be set forth in part in the description which follows, and in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings, of which:

FIG. 1 is a combined perspective view of a conventional refrigerator having a refrigerating compartment home bar door;

FIG. 2 is a sectional view of the conventional refrigerator of FIG. 1 showing an auxiliary refrigerating compartment and a refrigerating compartment home bar door;

FIG. 3 is a combined perspective view of a refrigerator according to a first embodiment of the present invention;

FIG. 4 is an exploded perspective view showing an auxiliary freezing compartment and a freezing compartment home bar door of the refrigerator of FIG. 3;

FIGS. 5A through 5C show operations of a hook device of the refrigerator of FIG. 3;

FIG. 6 is an exploded perspective view showing an auxiliary freezing compartment and a freezing compartment home bar door of a refrigerator according to a second embodiment of the present invention; and

FIG. 7 is a sectional view showing the auxiliary freezing compartment and the freezing compartment home bar door of the refrigerator of FIG. 6.

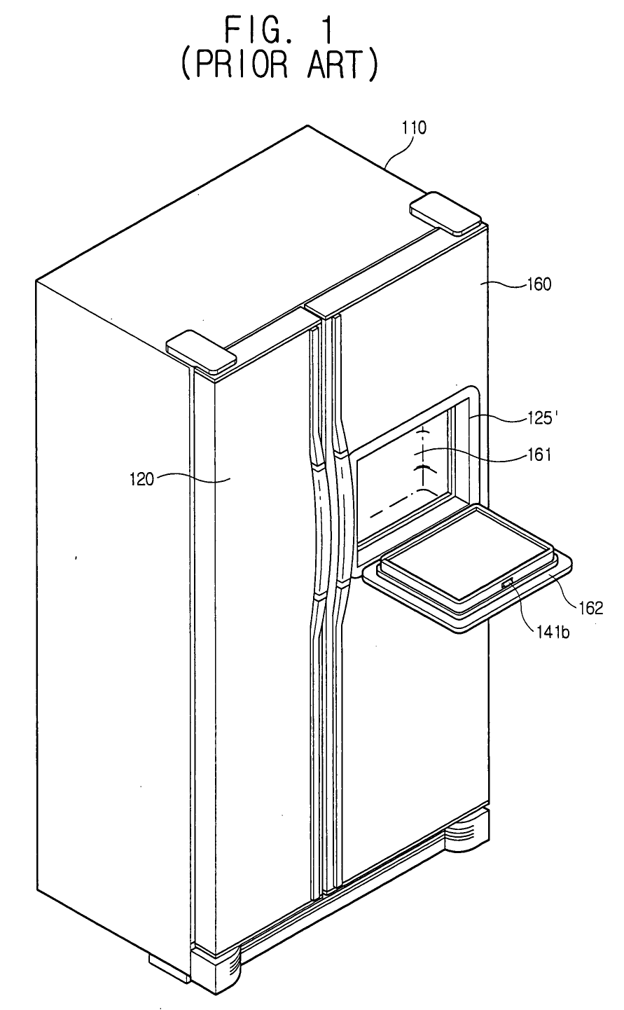

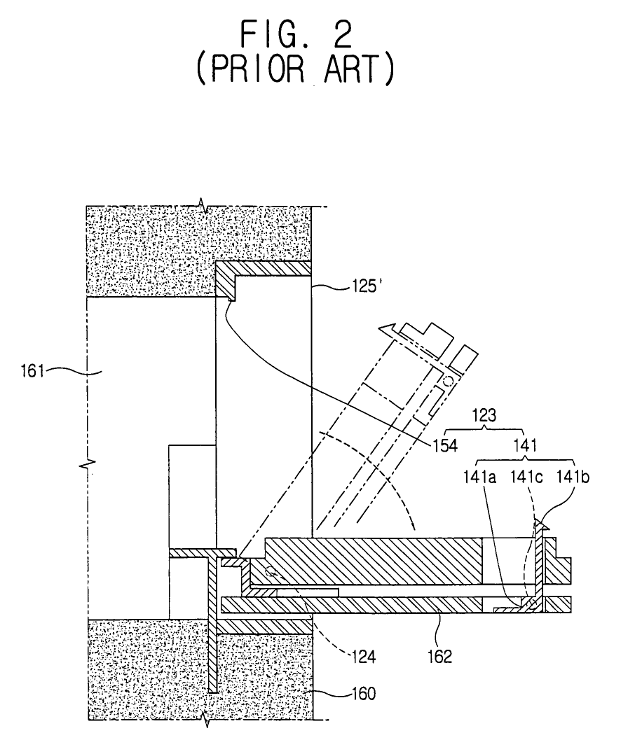

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

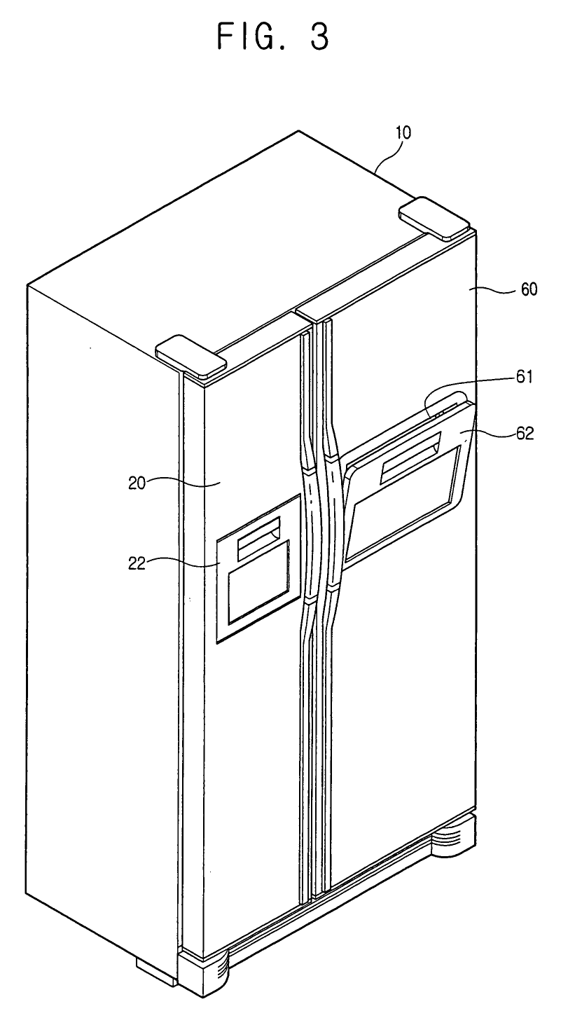

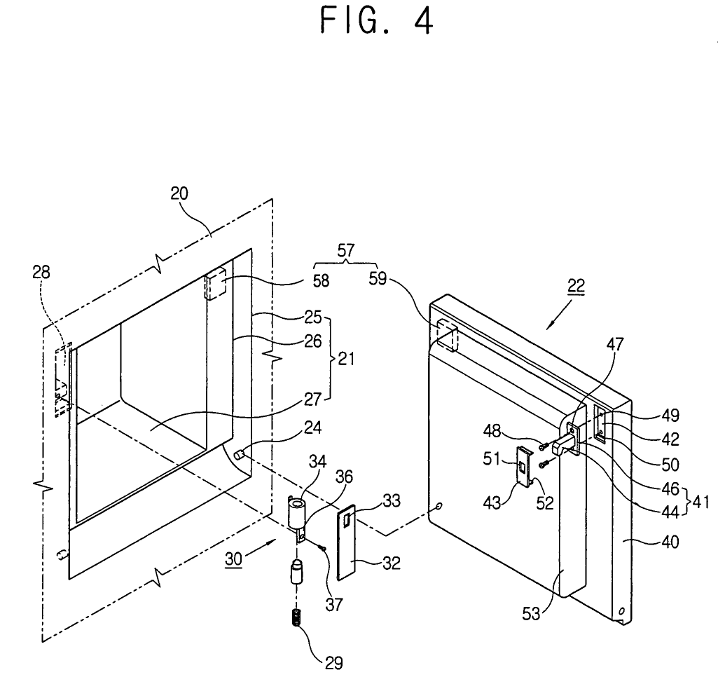

As is shown in FIGS. 3 and 4, a refrigerator according to a first embodiment of the present invention comprises a main body 10 divided by a partition into a freezing compartment and a refrigerating compartment, each having a front opening. Additionally, a freezing compartment door 20 and a refrigerating compartment door 60 are provided at the main body 10 to rotatably open the front openings of the freezing compartment and the refrigerating compartment, respectively.

The freezing compartment door 20 has an auxiliary freezing compartment 21 that allows a part of the freezing compartment in communication with the outside to accommodate food in the freezing compartment without opening the freezing compartment door 20. The auxiliary freezing compartment 21 has a front opening 25. The front opening 25 of the auxiliary freezing part 21 is opened/closed by a freezing compartment home bar door 22.

The refrigerating compartment door 60 has an auxiliary refrigerating compartment 61 that allows a part of the refrigerating compartment in communication with the outside to accommodate food in the refrigerating compartment without opening the refrigerating compartment door 60. The auxiliary refrigerating compartment 61 has a front opening 25. The front opening 25 of the auxiliary refrigerating compartment 61 is opened and closed by a refrigerating compartment home bar door 62.

The auxiliary freezing compartment 21 comprises a frame 26 provided outside the front opening 25 to contact with a front cover 40 (to be described later) of the freezing compartment home bar door 22, and is formed with a storing part 27 provided inside the frame 26 to store food.

The freezing compartment home bar door 22 comprises the front cover 40 to form a front external appearance, and a rear cover 53 provided behind the front cover 40, to be used as a shelf to put food thereon when the freezing compartment home bar door 22 is opened. At a lower part of the freezing compartment home bar door 22, there is provided a hinge 24 that allows the freezing compartment home bar door 22 to rotate with respect to the auxiliary freezing compartment 21 in an up-and-down direction.

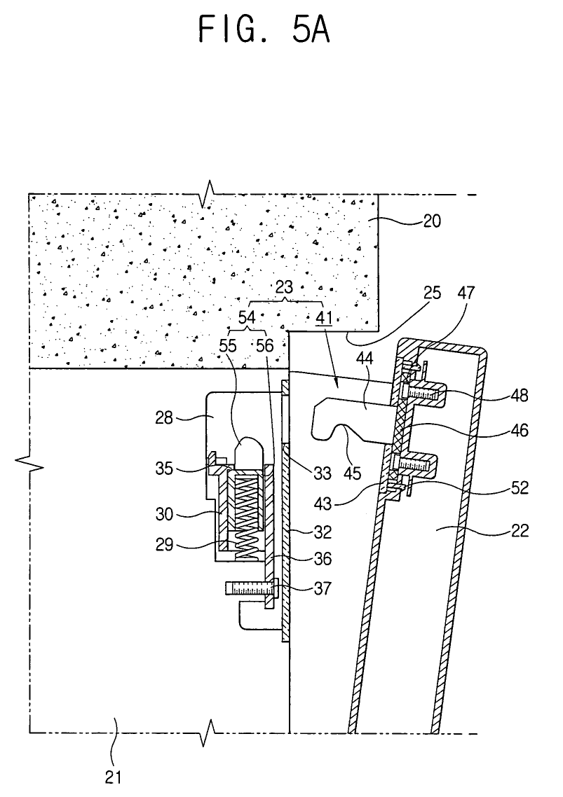

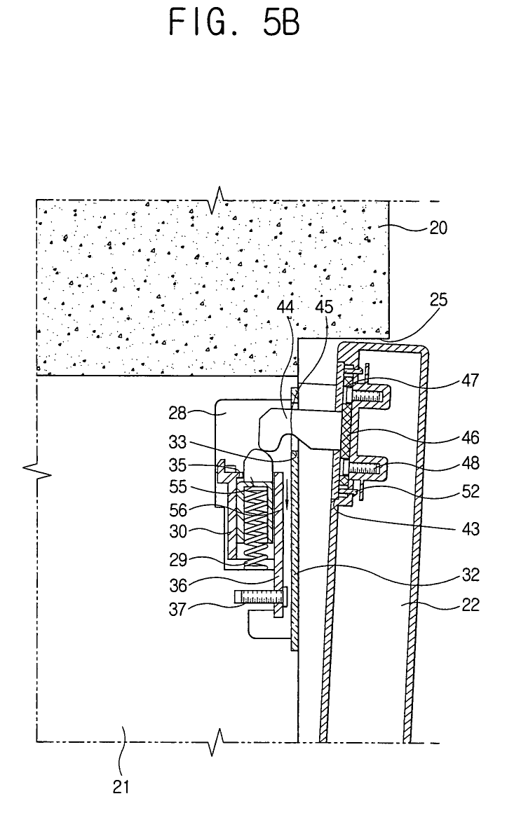

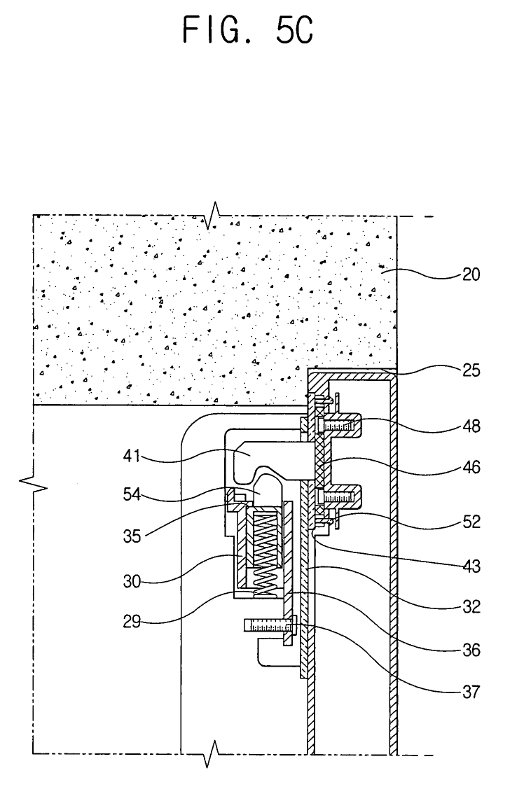

According to one aspect, a hook device 23 (see FIG. 5A) is provided between the auxiliary freezing compartment 21 and the freezing compartment home bar door 22 to be elastically locked and released when the freezing compartment home bar door 22 opens and closes the front opening 25.

The hook device 23 comprises a hook 41 mounted on the freezing compartment home bar door 22 and a locker 54 provided in the auxiliary freezing compartment 21 facing the hook 41, to be locked to and released from the hook 41.

The hook 41 comprises: a hook main body 44 provided at a side of the front cover 40 and having a locking recess 45, to accommodate the locker 54 when the freezing compartment home bar door 22 is in a closed position; and a hook supporter 46 to support the hook main body 44.

The hook supporter 46 is inserted in a hook accommodating part 42 grooved in the front cover 40, and has a first screw hole 47 on a surface thereof to connect the hook 41 to the front cover 40 with a screw 48. A hook cover 43 to cover the hook supporter 46 is connected to the hook accommodating part 42.

The hook accommodating part 42 has a second screw hole 49 to insert the screw 48 passing the first screw hole 47, and a protrusion hole 50 to insert a protrusion 52 (to be described later) of the hook cover 43.

The hook cover 43 has a first hook through hole 51 to insert the hook main body 44 through, and the protrusion 52, which is inserted in the protrusion hole 50 of the hook accommodating part 42.

The locker 54 is accommodated in a locker accommodating part 28 provided in the frame 26 of the auxiliary freezing compartment 21. The locker 54 comprises a locking protrusion 55 inserted in the locking recess 45 of the hook main body 44 and a locking extension 56 extending from a bottom of the locking protrusion 55.

The locker accommodating part 28 is provided with an elastic member 29 to elastically bias the locker 54, and a stopper 35 to prevent the locker 54 from getting out of the locker accommodating part 28.

A first side of the elastic member 29 is in contact with a bottom of the locker accommodating part 28 and a second side thereof is inserted in the locking extension 56 to be in contact with a top of the locking extension 56, thereby providing an elastic force.

The stopper 35 protrudes from a locker supporter 30 to accommodate and support the locker 54.

The locker supporter 30 is of a pillar shape having a groove therein to accommodate the locker 54 and the elastic member 29. An upper surface of the locker supporter 30 has a protrusion through hole 34 to insert the locking protrusion 55, and an inside circumference is provided with the stopper 35 to prevent the locking extension 50 from getting out of the locker supporter 30. The locker supporter 30 has a flange 36 with a hole, to screw-connect the locker supporter 30 to a supporter of the locker accommodating part 28 using a screw 37. A front of the locker accommodating part 28 is provided with a locker cover 32 to cover the locker accommodating part 28.

The locker cover 32 has a second hook through hole 33, so that the hook main body 44 passing through the first hook through hole 51 passes through the second hook through hole 33, to be locked to and released from the locker 54.

According to one aspect, the refrigerator further comprises a magnetic connector 57 to reinforce a connection of the hook device 23.

The magnetic connector 57 comprises: a permanent magnet 58 provided at an edge of either the auxiliary freezing compartment 21 or the freezing compartment home bar door 22; and a magnetic substance 59 provided at the other of the auxiliary freezing compartment 21 and the freezing compartment home bar door 22, to be attracted by the permanent magnet 58. According to one aspect, the magnetic connector 57 is provided at respective upper parts of the freezing compartment home bar door 22 and the auxiliary freezing compartment 21, and opposite the hook device 23.

According to one aspect, the permanent magnet 58 is mounted on a gasket to prevent a leakage of cooling air in the auxiliary freezing compartment 21 and the magnetic substance 59 is mounted in the front cover 40 of the freezing compartment home bar door 22 facing the permanent magnet 58.

The refrigerator according to the configuration described above provides a convenience to a user, as food required to be stored frozen can be stored in the freezing compartment without opening the freezing compartment door 20. Further, a noise emitted from the auxiliary freezing compartment 21 when the freezing compartment home bar door 22 is opened, may be reduced compared to a noise emitted from the freezing compartment when the freezing compartment door 20 is opened.

A description of an operation of the hook device 23 of the refrigerator according to the first embodiment of the present invention follows.

As is shown in FIG. 5A, when the freezing compartment home bar door 22 is opened with respect to the front opening 25, the hook 41 is released from the locker 54.

As is shown in FIG. 5B, if a user pushes the freezing compartment home bar door 22 backwardly to close the front opening 25, the hook main body 44 passes the second hook through hole 33 of the locker cover 32 and exerts force on the locking protrusion 55. Here, the locker 54 moves downwardly due to the force exerted by the hook main body 44 and presses the elastic member 29.

If the user further pushes the freezing compartment home bar door 22, the hook 41 passes an inclined surface of an end the locking protrusion 55. Here, the locker 54 moves up due to a restoring force of the elastic force 29 and is accommodated in the locking recess 45 of the hook main body 44, thereby being locked to the hook 41 (refer to FIG. 5C).

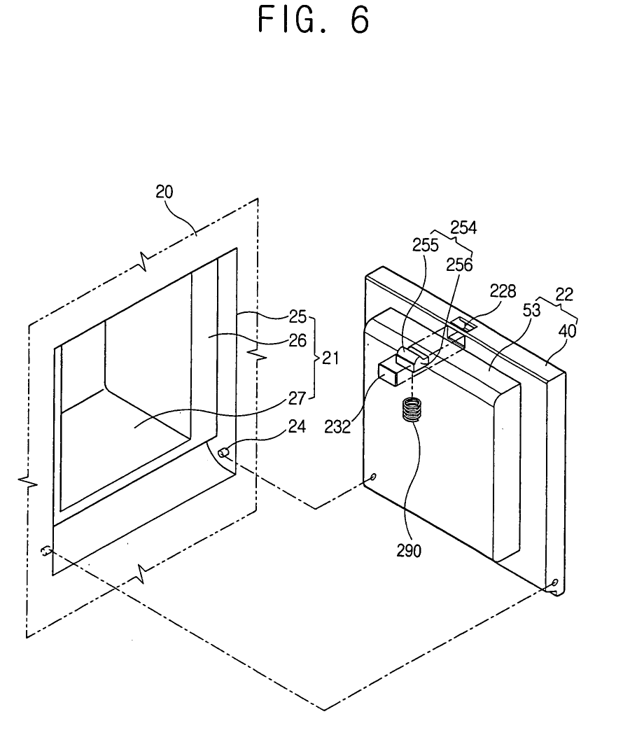

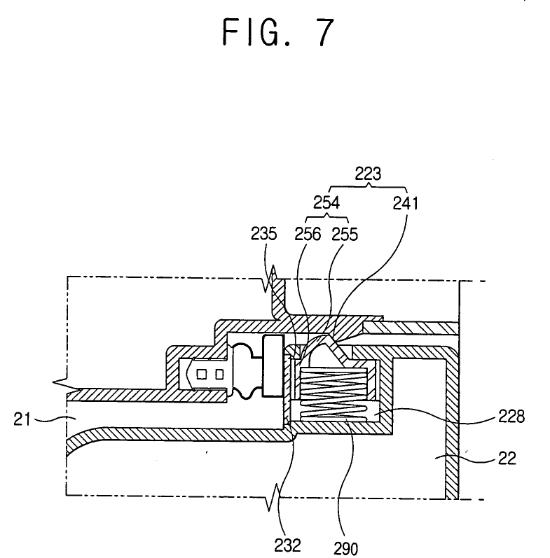

The present invention may be further embodied as a second embodiment shown in FIGS. 6 and 7. According to the second embodiment, a hook 241 is provided on the auxiliary freezing compartment 21, and a locker 254, elastically locked to and released from the hook 241, is provided in the freezing compartment home bar door 22.

The hook 241 protrudes at an upper part of the frame 26 and the locker 254 is accommodated in a locker accommodating part 228 of the front cover 40.

The locker 254 comprises a locking protrusion 255, and a locking extension 256 to accommodate an elastic member 290 therein. A locker cover 232 is provided to cover a locker accommodating part 228.

In the locker accommodating part 228, a stopper 235 protrudes to prevent the locker 254 from getting out of the locker accommodating part 228.

A description of an operation of the hook device 223 according to the second embodiment is avoided, as it is operated in the same way as the hook device 23 according to the first embodiment.

According to one aspect (not shown), the hook device 223 employs a magnetic device to reinforce a connection of the freezing compartment home bar door 22 and the auxiliary freezing compartment 21.

According to one aspect, the hinge 24 is provided at a side, so that the freezing compartment door is rotated in a right-and-left direction.

According to one aspect, the auxiliary freezing compartment 21 is not located on the freezing compartment door 20.

As is described above, the freezing compartment door 20 comprises the auxiliary freezing compartment 21 and the freezing compartment home bar door 22, which allows frozen storage of food without opening the freezing compartment door 20, and minimizes a leakage of cooling air from the freezing compartment.

Further, a noise emitted from the auxiliary freezing compartment when the freezing compartment home bar door 22 is opened may be minimized compared to a noise emitted from the freezing compartment when the freezing compartment door 20 is opened.

Although a few embodiments of the present invention have been shown and described, it would be appreciated by those skilled in the art that changes may be made in this embodiment without departing from the principles and spirit of the invention, the scope of which is defined in the claims and their equivalents.

1. A refrigerator comprising:
a main body with a freezing compartment and a refrigerating compartment, each compartment having a door opening;
a freezing compartment door and a refrigerating compartment door provided on the main body, to rotatably open and close the respective door openings;
an auxiliary freezing compartment, provided on the freezing compartment door to store food, and having an opening; and
a freezing compartment home bar door to open and close the opening of the auxiliary freezing compartment.

2. The refrigerator according to claim 1, wherein the refrigerating compartment door comprises:
an auxiliary refrigerating compartment to store food, having a opening and a refrigerating compartment home bar door to open and close the opening of the auxiliary refrigerating compartment.

3. The refrigerator according to claim 1, further comprising:
a hook device comprising
a hook provided at one of the auxiliary freezing compartment and the freezing compartment home bar door, and
a locker provided at the remaining one of the auxiliary freezing compartment and the freezing compartment home bar door, to be elastically locked with and released from the hook.

4. The refrigerator according to claim 3, further comprising:
a locker accommodating part provided at one of the auxiliary freezing compartment and the freezing compartment home bar door,
wherein the locker accommodating part is provided with
an elastic member to press the locker, and
a stopper to prevent the locker from escaping the locker accommodating part.

5. The refrigerator according to claim 4, further comprising:
a hinge provided at a lower part of the freezing compartment home bar door to allow the freezing compartment home bar door to rotate with respect to the auxiliary freezing compartment,
wherein the hook device is provided at an upper part of the freezing compartment home bar door.

6. The refrigerator according to claim 4, further comprising:
a magnetic connector comprising:
a permanent magnet provided at an edge of one of the auxiliary freezing compartment and the freezing compartment home bar door, and
a magnetic substance provided at the remaining one of the auxiliary freezing compartment and the freezing compartment home bar door to cooperate with the permanent magnet.

7. The refrigerator according to claim 6, further comprising:
a hinge provided at a lower part of the freezing compartment home bar door to allow the freezing compartment home bar door to rotate with respect to the auxiliary freezing compartment,
wherein the hook device and the magnetic connector are oppositely disposed at an upper part of the freezing compartment home bar door.

8. A refrigerator having a main body including a freezing compartment and a refrigerating compartment, each compartment having a door opening and a door to open and close the door opening, the refrigerator comprising:
an auxiliary freezing compartment to freeze and store food, accessible by a user without opening the freezing compartment door.

9. The refrigerator according to claim 8, wherein the auxiliary freezing compartment is positioned on the freezing compartment door.

10. The refrigerator according to claim 8, further comprising:
an auxiliary refrigerating compartment, positioned on the refrigerating compartment door to refrigerate and store food.

11. The refrigerator according to claim 8, wherein:
the auxiliary freezing compartment has an opening; and
the refrigerator further comprises a freezing compartment home bar door to open and close the opening of the auxiliary freezing compartment.

12. The refrigerator according to claim 11, further comprising:
a frame positioned in the opening of the auxiliary freezing compartment; and
a hinge positioned on the frame, about which the freezing compartment home bar door rotates to open and close the opening of the auxiliary freezing compartment.

13. The refrigerator according to claim 12, wherein the hinge is positioned such that the freezing compartment home bar door rotates about an approximately horizontal axis.

14. The refrigerator according to claim 12, wherein the hinge is positioned such that the freezing compartment home bar door rotates about an approximately vertical axis.

15. The refrigerator according to claim 12, further comprising:
a hook device to selectively lock and release the freezing compartment home bar door.

16. The refrigerator according to claim 15, wherein the hook device comprises:
a hook provided at one of the auxiliary freezing compartment and the freezing compartment home bar door; and
a locker provided at the remaining one of the auxiliary freezing compartment and the freezing compartment home bar door to be selectively engaged with the hook, to lock and release the freezing compartment home bar door.

17. The refrigerator according to claim 16, wherein:
the one of the auxiliary freezing compartment and the freezing compartment home bar door has a hook accommodating part to accommodate a hook; and
the remaining one of the auxiliary freezing compartment and the freezing compartment home bar door has a locker accommodating part to accommodate the locker.

18. The refrigerator according to claim 17, further comprising:
an elastic member, elastically biasing a locking protrusion that engages a locking recess of a hook main body; and
a locker supporter,
connected with the locker accommodating part,
housing at least portions of the locking protrusion, a locking extension extending from the locking protrusion, and the elastic member, and
having a stopper to maintain the locker in the locker accommodating part.

19. The refrigerator according to claim 16, wherein:
the hook protrudes from the one of the auxiliary freezing compartment and the freezing compartment home bar door; and
the locker comprises
a locking protrusion to selectively engage the hook,
an elastic member to elastically bias the locking protrusion, and
a locking extension extending from the locking protrusion and housing at least a portion of the elastic member.

20. The refrigerator according to claim 19, wherein:
the remaining one of the auxiliary freezing compartment and the freezing compartment home bar door has a locker accommodating part accommodating the locker and having a stopper and an opening;
the locking protrusion protrudes through the opening of the locker accommodating part to selectively engage the hook;
a first end of the elastic member contacts the locker accommodating part and a second end of the elastic member contacts the locking extension, to bias the locking protrusion toward the opening of the locker accommodating part; and
the stopper engages the locking extension to maintain the locker in the locker accommodating part.
